(19) United States
(12) Patent Application Publication
(10) Pub. No.: US 2016/0316021 A1
(43) Pub. Date: Oct. 27, 2016

(54) REMOTE OUT OF BAND MANAGEMENT

(71) Applicant: CradlePoint, Inc., Boise, ID (US)

(72) Inventor: GREGORY T. ANDERSEN, Boise, ID (US)

(21) Appl. No.: 14/930,538

(22) Filed: Nov. 2, 2015

Related U.S. Application Data
(60) Provisional application No. 62/153,140, filed on Apr. 27, 2015.

(51) Int. Cl. H04L 29/08; H04W 12/08; H04L 29/06

(52) U.S. Cl. CPC H04L 67/14; H04L 67/10; H04L 63/10; H04W 12/08

(57) ABSTRACT

Disclosed embodiments include a system having a router with a secured communication channel and a first API, an enterprise cloud manager in communication with the router over the secured communication channel and further in communication with a computing device and the enterprise cloud manager further comprising a second API, and wherein the second API establishes a console session on the router by a request to the first API.

### CROSS-REFENENCE TO RELATED APPLICATIONS

This application, under 35 U.S.C. §119, claims the benefit of U.S. Provisional Patent Application Ser. No. 62/153,140 filed on Apr. 27, 2015, and titled “A Method To Remotely Establish An Interactive Device Console Through REST Proxied Requests,” the contents of which are hereby incorporated by reference herein.

### FIELD OF THE DISCLOSURE

The present disclosure relates generally to systems and methods for remotely managing network assets and components. In particular, the present disclosure relates to systems and methods to remotely establish an interactive device console through representational state transfer (REST) proxied requests.

### BACKGROUND

Routers allow client devices in a local area network (LAN) to access a wide area network (WAN). Connections between client devices and the router may be wired or wireless. Similarly, connections between the router and the WAN may be wired or wireless. Wireless connections to the WAN may be through a cellular network.

Often network assets and components are protected behind a firewall or other network address translation (NAT) configuration that protects the network assets and components. As used herein, “network assets” refer to any device, hardware, software, data, or other components that comprise the network.

Typically, inbound communication to the network asset is blocked by the firewall and configuration of the network asset requires either that an administrator be present (i.e., inside the firewall), or that the administrator can remotely connect and interact with a console of the network asset through a secure outbound connection initiated from the network asset and network infrastructure in order to propagate and secure an interactive session via that outbound channel. In most cases, such an outbound connection requires a peer that is accessible externally to the network. Additionally that external peer must support the propagation infrastructure that the network asset to be configured provides.

In other existing systems, configuration of a network asset via console session establishment may, generally, be done using a Secure Shell (SSH) protocol that allows establishing an outbound connection to an external peer and tunneling another SSH session across the initial connection in the reverse direction. This kind of session typically requires persistent socket connections to the network asset to be configured and does not allow for asynchronous requests. These and other drawbacks of existing systems exist.

### SUMMARY

Accordingly, the disclosed systems and methods address the above, and other, situations by enabling proxied REST requests to an internal network asset and providing an interactive session to a third entity which normally would not have interactive capabilities with the internal network asset.

Disclosed embodiments include a system having a router with a secured communication channel and a first API, an enterprise cloud manager in communication with the router over the secured communication channel and further in communication with a computing device and the enterprise cloud manager further comprising a second API, and wherein the second API establishes a console session on the router by a request to the first API.

In addition, disclosed embodiments include a router having a serial connection port and the system includes a network asset connected to the router via the serial connection port, and wherein the second API establishes a console session on the network asset by a request to the first API.

In some disclosed embodiments, the first API and the second API are a REST API. In further disclosed embodiments the console session may be an asynchronous proxied REST session.

In still further disclosed embodiments, system includes a second network asset connected to the router via the serial connection port, and wherein the second API establishes a console session on the second network asset by a request to the first API.

Disclosed methods include establishing a secured communication channel between an enterprise cloud manager comprising a first API and a router comprising a second API, sending a request to initiate a console session over the secured channel from the first API to the second API, and establishing a console session on the router in response to the request to initiate a console session.

In further disclosed embodiments the method may include communicating subsequent asynchronous proxied requests between the first API and the second API. In still further embodiments the method may include the first API and the second API are REST APIs. In still further embodiments the console session comprises an asynchronous proxied REST session.

In some disclosed embodiments the method includes serially connecting a network asset to the router via a serial connection port, and sending a request to initiate a console session over the secured channel from the first API to the second API, and establishing a console session on the network asset in response to the request to initiate a console session. In still further embodiments the method may include serially connecting a second network asset to the router via the serial connection port, and sending a request to initiate a console session over the secured channel from the first API to the second API, and establishing a console session on the second network asset in response to the request to initiate a console session. Other features and advantages of disclosed systems and methods also exist and will be apparent from the following description.

### BRIEF DESCRIPTION OF THE DRAWINGS

FIG. 1 is an exemplary environment in which the presently disclosed systems and methods may be implemented.

FIG. 2 is a block diagram illustrating exemplary physical and logical components of router 26, according to embodiments of the present disclosure.

FIG. 3 is a block diagram illustrating exemplary physical and logical components of router 26, according to embodiments of the present disclosure.

FIG. 4 is a schematic illustration of embodiments of the disclosure showing some possible connections.

FIG. 5 is a schematic illustration of serial connection of a plurality of network assets in accordance with embodiments of the disclosure.

FIG. 6 schematically illustrates communication paths for embodiments of the disclosure.

FIG. 7 shows exemplary interface windows that may be implemented in conjunctions with the ECM 46 in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

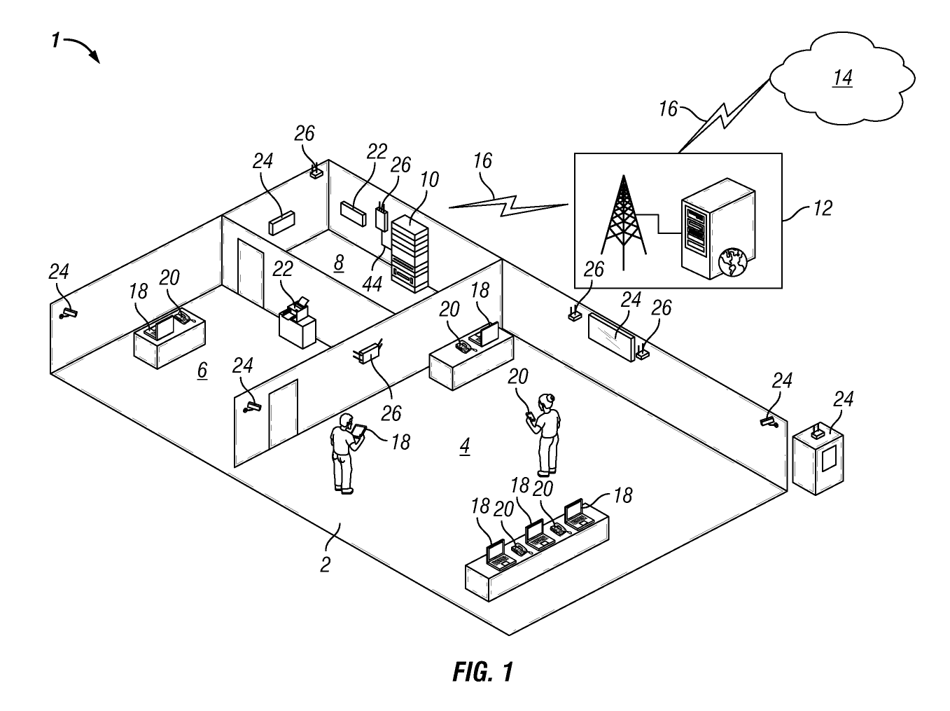

FIG. 1 is an exemplary environment in which the presently disclosed systems and methods may be implemented. As shown, environment 1 may comprise a retail establishment 2 which may further comprise a customer area 4, a back office area 6, and an equipment room 8. Environment 1 may further comprise one or more servers 10. Among other things, servers 10 may comprise part of a LAN in use in the customer area 4 and back office 6 and may also communicate with a WAN, an internet service provider (ISP) 12, and ultimately with the Internet 14. Communication between the servers 10 and the various networks may be accomplished over links 16 which represents generally any combination of a cable, wireless, or remote connection via a telecommunication link, an infrared link, a radio frequency link, or any other connector or system that provides electronic communication between servers 10 and the various networks.

As also indicated in FIG. 1, environment 1 may also comprise any number of computing devices and other peripherals and related systems (collectively, and individually “client devices”). For example, customer area 4 and back office 6 may comprise computing devices 18 (e.g., point-of-sale terminals, associate terminals, manager computers, employee tablet devices, etc.), communication devices 20 (e.g., voice-over-internet-protocol (“VoIP”) telephones, customer cellular phones, customer smartphones, etc.), and peripheral devices 22 (e.g., printers, fax machines, hard drives, storage drives, etc.).

As also indicated, environment 1 may also include other systems 24 (e.g., HVAC control systems, security systems, digital signage systems, kiosks, etc.) that communicate over one or more networks in environment 1. Other types of systems may also be included in environment 1.

One or more routers 26 may also be included in environment 1. Router 26, discussed in more detail later, represents generally a device capable of routing network communications between client devices (e.g., computing devices 18, communication devices 20, peripheral devices 22, and other systems 24) and Internet 14 via a data exchanger 28.

Data exchanger 28 represents generally any combination of hardware and/or programming that can be utilized by router 10 to connect to a remote network such as the internet. In the example of FIG. 1, the data exchanger 28 and routers 26 are incorporated within the same device and can be connected, for example, by using internal connections. In an embodiment, the data exchanger 28 may take the form of a separate device card that can be inserted into a slot provided by router 26, or otherwise connected to the router 26 through an I/O port. Alternatively, the data exchanger 28 may be fully integrated into router 26.

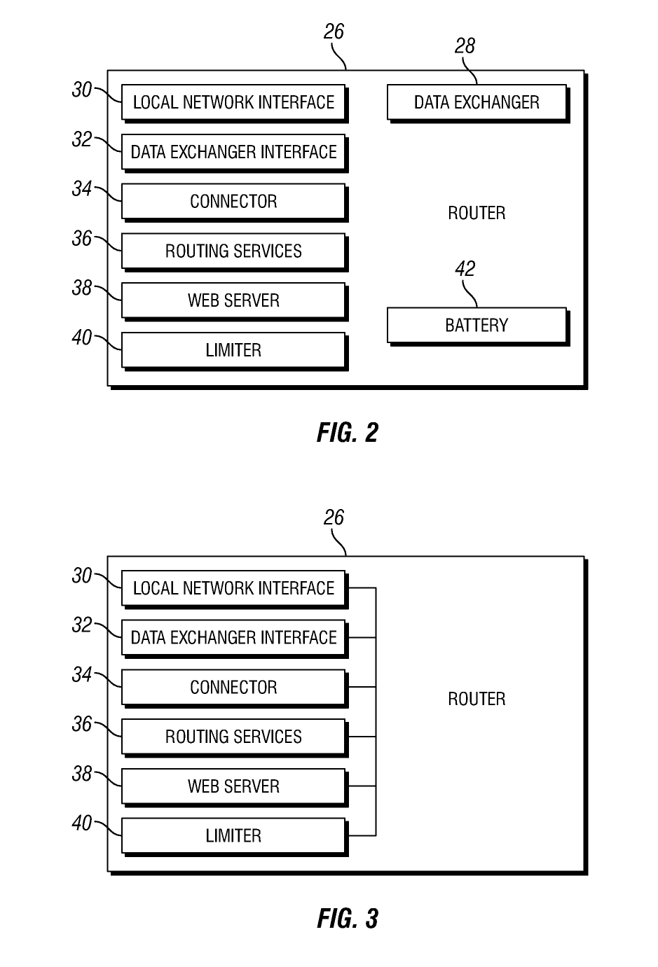

FIG. 2 is a block diagram illustrating exemplary physical and logical components of router 26, according to an embodiment of the present disclosure. As described above, router 26 represents generally any combination of hardware and/or programming capable functioning as a router for directing network communications between client devices on the local network, or between client devices and the internet via a data exchanger such as an internet enabled cellular telephone, cellular modem, DSL modem, or cable modem.

In the example of FIG. 2, router 26 includes local network interface 30 and data exchanger interface 32. Local network interface 30 represents generally any combination of hardware and/or program instructions capable of supplying a communication interface between router 26 and computing devices 18, communication devices 20, and peripheral devices 22 as shown in FIG. 1.

Data exchanger interface 32 represents any combination of hardware and/or programming enabling data to be communicated between router 26 and a data exchanger 28. For example, interfaces 30 and 32 may include a transceiver operable to exchange network communications utilizing a wireless protocol such as ultrawideband (UWB), Bluetooth, or 802.11. Alternatively, interfaces 30 and 32 may include physical ports or other physical connection points enabling wired communication.

In an embodiment, as illustrated in FIG. 2, router 26 can also include an embedded data exchanger 28 in addition to the data exchanger interface 32. As shown in FIG. 1, data exchanger 28 allows router 26 to connect directly to ISP 12 via link 16, as opposed to employing a separate data exchanger device. In the case of a data exchanger 28 being embedded in router 26, router 26 can include a data exchanger interface 32 such as, for example, a slot for a device card, such as a cellular modem, or the like, which allows communication with the embedded data exchanger 28. Alternatively, the embedded data exchanger 28 can be fully integrated into the router 26, in which case the data exchanger interface 32 may be replaced with internal device connections.

In an embodiment, router 26 can also include router services 36 and web server 38. Routing services 36 represents generally any combination of hardware and/or programming for routing network communication received through network interface 30 to be transmitted by data exchanger 28 to internet 14. Routing services 36 can also be responsible for routing inbound network communications received from internet 14 and directed via network interface 30 to a specified computing device 18, communication device 20, or peripheral device 22. Outbound and inbound network communications, for example can be IP (internet protocol) packets directed to a target on internet 14 or to a particular networked device 18, 20, 22 on a LAN.

Web server 38 represents generally any combination of hardware and/or programming capable of serving interfaces such as web pages to networked devices 18, 20, and 22. Such web pages may include web pages that when displayed by a network device allows a user to provide or otherwise select settings related to the operation of router 26.

Router 26 can optionally include a connector 34. Connector 34 represents generally any combination of hardware and/or programming for sending a signal to data exchanger 28 to establish a data connection with service providers 12 so that access can be made to internet 14. For example, where a data exchanger 28 is a cellular telephone, connector 34 may send a signal causing the cellular telephone to establish a data link with service provider 12. In an embodiment, the router 26 does not include a connector 34. In an embodiment, the hardware and/or programming for establishing a data connection with a service provider 12 is included in, for example, a cellular modem that is employed as the data exchanger 28, which may be incorporated into router 26, as described above.

The router 26 can optionally include a limiter 40. Limiter 40 represents generally any combination of hardware and/or programming capable of distinguishing among the users of devices such as networked assets 18, 20, and 22, and applying different internet access rules for different users. For example, certain internet access rules may apply to the owner of router 26. In this context, the term owner refers to an individual or entity that is a subscriber with respect to a service provider such as service provider 12 shown in FIG. 1. The owner typically has physical possession or otherwise has control of router 26. Other internet access rules can apply to users authorized by the owner. Yet other internet access rules apply to anonymous users. Where network interface 30 provides for a wireless connection with networked assets 18, 20, and 22, a user of a particular device might not be known by the owner. As such, internet access rules for such users may be quite limiting. The limiter 40 and operation thereof are discussed in greater detail in U.S. patent application Ser. No. 11/673,956, filed Feb. 12, 2007, in the name of Pat Sewall, et al., the disclosure of which is hereby incorporated by reference in its entirety.

In an embodiment, one or more of the features shown in FIGS. 2 and 3 may not be included. For example, router 26 can include a local network interface 30, a data exchanger interface 32, a connector 34, routing services 36, a web server 38 and a data exchanger 28, but not a limiter 40. In an embodiment, router 26 may optionally include a battery 42 or other form of self-contained source of power to provide electrical power for the router 26 to function. As shown in FIGS. 2 and 3, and described above, router 26 may not have an embedded or enclosed data exchanger 28, but instead may employ an external data exchanger 28 that is connected to the router 26 through a device link 44. Device link 44 may be any suitable link, such as a cable, or a direct physical connection between the data exchanger 28 and the router 26, or a form of wireless communication.

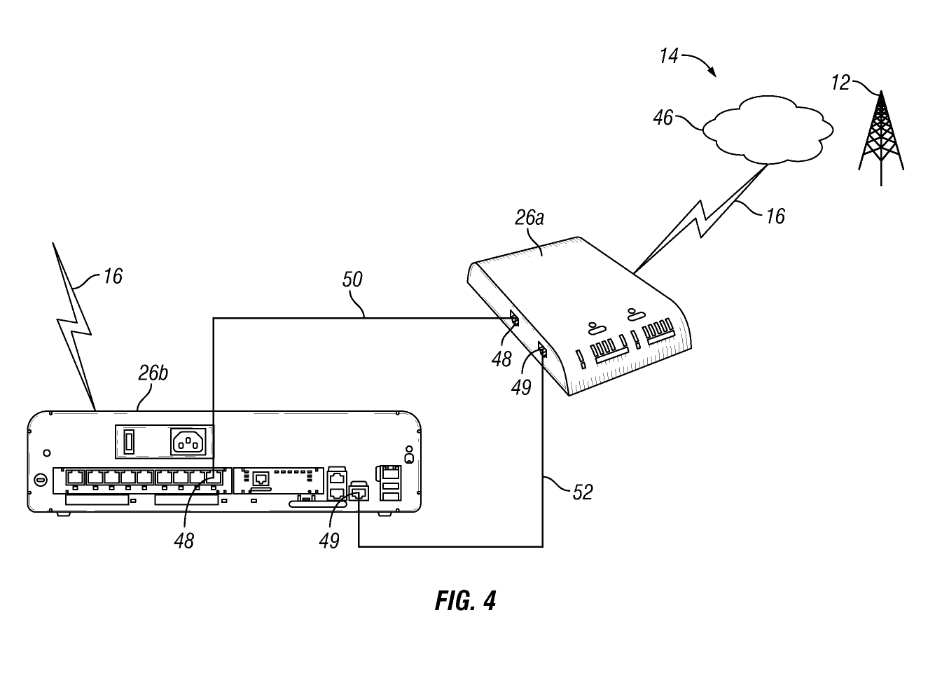

FIG. 4 is a schematic illustration of embodiments of the disclosure showing some possible connections. As shown, a wireless router 26a may communicate over a cellular link 16 to the Internet 14 over a service provided by an ISP 12. As also illustrated, an enterprise cloud manager (“ECM”) 46 may reside on the Internet 14. ECM 46 may comprise an Application Program Interface (“API”) and other network management tools that may enable remote management of an environment 1 and the networks contained therein. The API may comprise a REST API 54. ECM 46 may enable the remote monitoring of status of network assets (e.g., 18, 20, 22, or 24) and may enable to generation of network analytics, diagnostics, or the like.

As also illustrated, wireless router 26a may also have a number of connection ports 48, 49. For example, connection ports may comprise RF connection ports (e.g., WiFi, Zigbee, Bluetooth, cellular, or the like (not shown), Ethernet connection ports 48, serial connection ports 49, or the like. As illustrated, wireless router 26a may be connected to a primary router 26b using an Ethernet connection 50 via Ethernet connection ports 48, or a serial connection 52 may be established via corresponding serial connection ports 49. AS illustrated primary router 26b may reside on a network (e.g., LAN, WAN, or the like) in environment 1 and may communicate with network assets via a wired or wireless link 16.

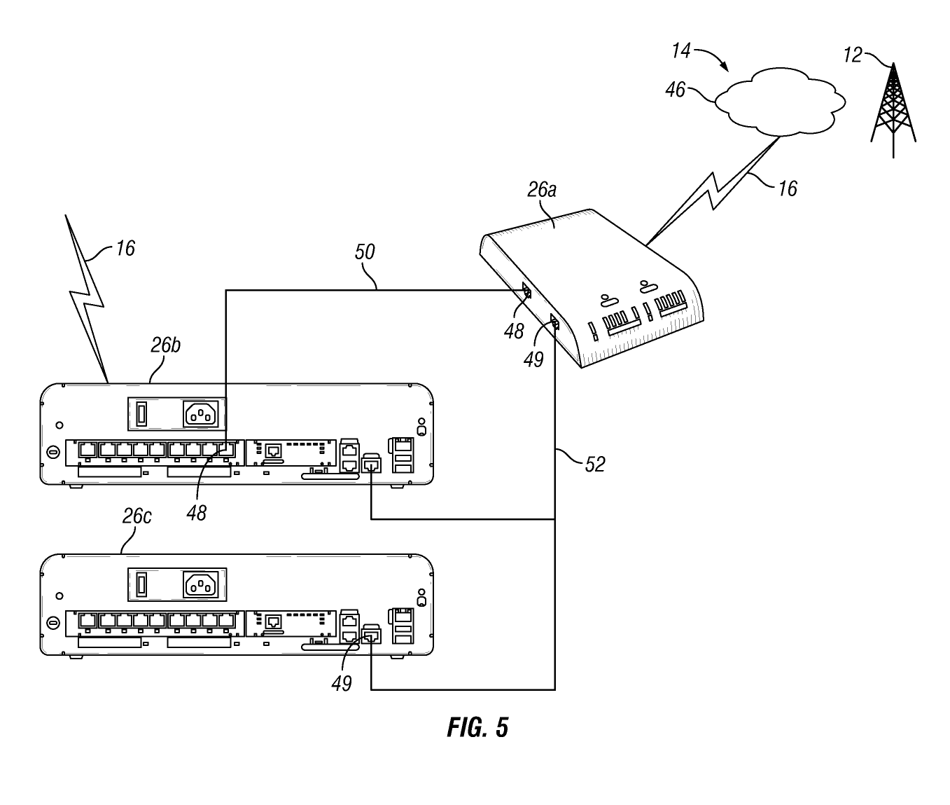

FIG. 5 is an illustration of serial connection of a plurality of network assets in accordance with embodiments of the disclosure. As illustrated an additional network asset (e.g., router 26c) may be connected via serial connection 52 to wireless router 26a. Of course, additional network assets may be connected as desired.

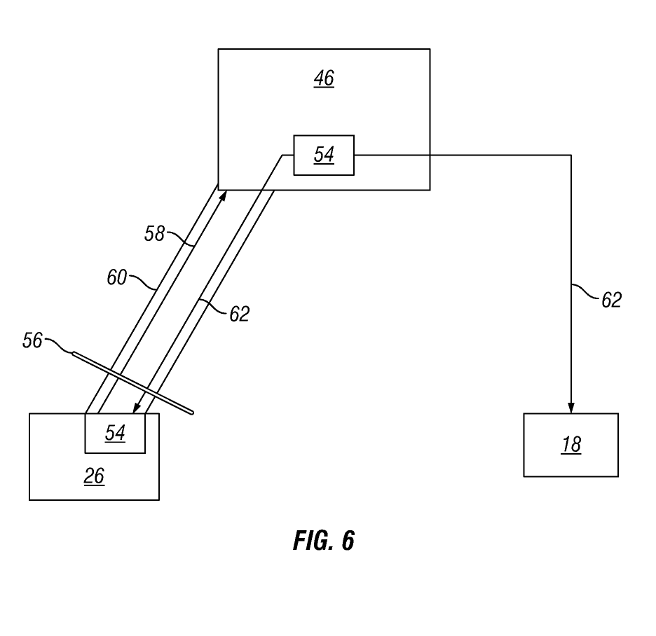

FIG. 6 schematically illustrates communication paths for embodiments of the disclosure. As indicated schematically, a router 26 may connect to the Internet 14 and receive a network address translation (NAT) IP address that cannot be reached on the public Internet 14, thus setting up an ISP firewall/NAT 56 through which inbound remote access to the router 26 is not possible. In some embodiments, router 26 may then establish outbound communication 58 to ECM 46 via a SSL secured channel 60. As noted above, embodiments of ECM 46 may comprise a REST API 54, corresponding parts of which may also reside on router 26. In this manner, communication for additional external entities with access to the ECM 46 may be made via an SSL secured channel 60 and the REST API 54.

For example, in embodiments, an external entity may connect to the ECM 46 (e.g., an authorized user, external to or remote from the router 26, may access the Internet 14 via computing device 18 to log into the ECM 46) and send a REST request via REST API 54 for a new console session on router 26, or any network asset connected to router 26 via serial connection 52 (e.g., router 26b, 26c, etc., as described with reference to FIGS. 4-5). The ECM 46 and REST API 54 proxies the REST request to the router 26 (or other serially connected 52 network asset) via the previously established SSL secured channel 60. Router 26 (or other serially connected 52 network asset) responds to the request with session handshake and other initial data and subsequent asynchronous proxied REST requests continue pack and forth as indicated at 62 until the session completes.

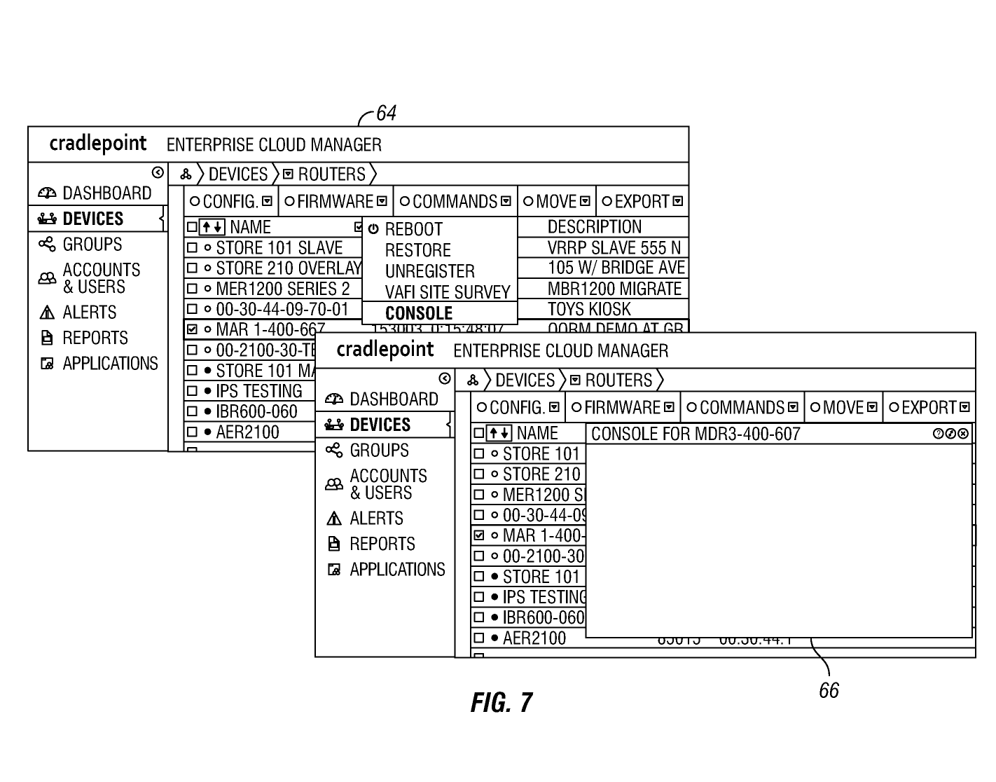

FIG. 7 shows exemplary interface windows that may be implemented in conjunctions with the ECM 46 in accordance with disclosed embodiments. For example, ECM 46 may comprise an interface window 64 with various, software interfaces that enable a user to establish the connections with the remote network asset (e.g., router 26 or other serially connected 52 network asset) as discussed in connection with FIG. 6. As also shown schematically, a console session interface window 66 may enable a user to enter a console session with the remote network asset (e.g., router 26 or other serially connected 52 network asset) and perform configuration, troubleshooting, repair, diagnostic, or other operations as desired.

Although various embodiments have been shown and described, the present disclosure is not so limited and will be understood to include all such modifications and variations are would be apparent to one skilled in the art.

What is claimed is:

1. A system comprising:
a router comprising a secured communication channel and a first API;
an enterprise cloud manager in communication with the router over the secured communication channel and further in communication with a computing device and the enterprise cloud manager further comprising a second API; and
wherein the second API establishes a console session on the router by a request to the first API.

2. The system of claim 1 wherein the router further comprises a serial connection port and the system further comprising:
a network asset connected to the router via the serial connection port; and
wherein the second API establishes a console session on the network asset by a request to the first API.

3. The system of claim 1 wherein the first API and the second API are a REST API.

4. The system of claim 3 wherein the console session comprises an asynchronous proxied REST session.

5. The system of claim 2 further comprising:
a second network asset connected to the router via the serial connection port; and
wherein the second API establishes a console session on the second network asset by a request to the first API.

6. A method comprising:
establishing a secured communication channel between an enterprise cloud manager comprising a first API and a router comprising a second API;
sending a request to initiate a console session over the secured channel from the first API to the second API; and
establishing a console session on the router in response to the request to initiate a console session.

7. The method of claim 6 further comprising:
communicating subsequent asynchronous proxied requests between the first API and the second API.

8. The method of claim 6 wherein the first API and the second API are REST APIs.

9. The method of claim 6 wherein the console session comprises an asynchronous proxied REST session.

10. The method of claim 6 further comprising:
serially connecting a network asset to the router via a serial connection port; and
sending a request to initiate a console session over the secured channel from the first API to the second API; and
establishing a console session on the network asset in response to the request to initiate a console session.

11. The method of claim 10 further comprising:
serially connecting a second network asset to the router via the serial connection port; and
sending a request to initiate a console session over the secured channel from the first API to the second API; and
establishing a console session on the second network asset in response to the request to initiate a console session.
